(19) United States
(12) Patent Application Publication
(10) Pub. No.: US 2024/0202418 A1
(43) Pub. Date: Jun. 20, 2024

(54) DESIGN SUPPORT APPARATUS, DESIGN SUPPORT PROGRAM, AND DESIGN SUPPORT METHOD

(71) Applicants: Flosfia Inc., Kyoto (JP); Mitsubishi Heavy Industries, Ltd., Tokyo (JP)

(72) Inventors: Masato Ito, Tokyo (JP); Masaya Mitake, Tokyo (JP); Kengo Takeuchi, Kyoto (JP); Toshimi Hitora, Kyoto (JP); Fujio Okui, Kyoto (JP)

(21) Appl. No.: 18/430,948

(22) Filed: Feb. 2, 2024

Related U.S. Application Data
(63) Continuation-in-part of application No. PCT/JP2022/029866, filed on Aug. 3, 2022.

(30) Foreign Application Priority Data
Aug. 4, 2021 (JP) 2021-128633

(51) Int. Cl. G06F 30/392

(52) U.S. Cl. CPC G06F 30/392

(57) ABSTRACT

A design support apparatus supports design of a component embedded substrate including an embedded electronic component that configures at least a part of a circuit. The apparatus includes a component information acquiring unit that acquires component information containing component identifying information about the electronic component to be incorporated in the substrate, a pad information acquiring unit that acquires pad information about a type and number of electrode pads to be arranged on the substrate based on the component information, a mounting arrangement information acquiring unit that acquires mounting arrangement information about the arrangement of the substrate and another component on a mounting board in which the component embedded substrate is to be incorporated, and a pad arrangement selecting unit that selects the arrangement of the electrode pad on a surface of the substrate based on the mounting arrangement information and the pad information.

### CROSS REFERENCE TO RELATED APPLICATION

This application is a continuation-in-part application of International Patent Application No. PCT/JP2022/029866 (Filed on Aug. 3, 2022), which claims the benefit of priority from Japanese Patent Application No. 2021-128633 (filed on Aug. 4, 2021).

The entire contents of the above applications, which the present application is based on, are incorporated herein by reference.

### 1. FIELD OF THE INVENTION

The disclosure relates to a design support apparatus, a design support program, and a design support method intended to support designs of a circuit and a module or design of the circuit or the module.

### 2. DESCRIPTION OF THE RELATED ART

In mounting a semiconductor module on a mounting board, etc., increase in functions of a chip involves complication of design of a wiring for connection on a wiring board with an incorporated semiconductor chip between the semiconductor chip and an electric component such as another semiconductor chip, a resistor, or a capacitor, for example. In recent years, mounting design using a multi-chip module (MCM) or a chip size package (CSP) has been made actively, for example. Such mounting design is made using a design technique of mounting a component on a high-density substrate (hereinafter also called a “subordinate substrate”) and mounting the subordinate substrate on a master substrate while treating the subordinate substrate with the mounted component in its entirety as one component.

For example, there is a substrate design apparatus disclosed as a substrate mounting design apparatus that makes mounting design of a master substrate and mounting design of a subordinate substrate simultaneously in conjunction with each other. This apparatus includes: mounting data storage means that stores at least data about the positions, shapes, and dimensions of a master substrate, one or more subordinate substrates to be arranged on the master substrate, and components, and connection information about connection between terminals belonging to each of the components; component shape data storage means that stores a candidate for component shape data about the shape and dimension of a component in each of a case where the subordinate substrate and each of the components are to be arranged at positions on the master substrate and a case where these positions are to be defined on the subordinate substrate; component classifying means that classifies all components yet to be arranged into a component to be arranged on the subordinate substrate and a component to be arranged on the master substrate; subordinate substrate shape determining means that selects component shape data about the subordinate substrate from the candidate for the component shape data on the basis of the component to be arranged on the subordinate substrate classified by the component classifying means; component arranging means for master substrate that arranges the component to be arranged on the master substrate and the subordinate substrate on the master substrate on the basis of connection information about connection between the component to be arranged on each of the subordinate substrates and the component to be arranged on the master substrate; and component arranging means for subordinate substrate that arranges the component on each of the subordinate substrate that is to be arranged on the subordinate substrate on the basis of connection information about connection to the component arranged on the master substrate.

### SUMMARY OF THE INVENTION

According to an example of the present disclosure, there is provided a design support apparatus that supports design of a component embedded substrate including an embedded electronic component that configures at least a part of a circuit, the apparatus including at least: a component information acquiring unit that acquires component information containing at least component identifying information about the electronic component to be incorporated in the component embedded substrate; a pad information acquiring unit that acquires pad information about a type and the number of electrode pads to be arranged on the component embedded substrate on the basis of the component information; a mounting arrangement information acquiring unit that acquires mounting arrangement information as arrangement information about arrangement of the component embedded substrate and another component on a mounting board in which the component embedded substrate is to be incorporated; and a pad arrangement selecting unit that selects arrangement of the electrode pad on a surface of the component embedded substrate on the basis of the mounting arrangement information and the pad information.

According to an example of the present disclosure, there is provided a design support program that supports design of a component embedded substrate including an embedded electronic component that configures at least a part of a circuit, the program causing a computer to perform: a process of acquiring component information about the electronic component to be incorporated in the component embedded substrate; a process of acquiring pad information about a type and the number of electrode pads to be arranged on a surface of the component embedded substrate on the basis of the component information; a process of acquiring mounting arrangement information about arrangement of the component embedded substrate and another component on a mounting board; and a process of selecting arrangement of the electrode pad on the basis of the mounting arrangement information and the pad information.

According to an example of the present disclosure, there is provided a design support method of supporting design of a component embedded substrate including an embedded electronic component that configures at least a part of a circuit, the method including at least: acquiring component information about the electronic component to be incorporated in the component embedded substrate; acquiring pad information about a type and the number of electrode pads to be arranged on a surface of the component embedded substrate on the basis of the component information; acquiring mounting arrangement information about arrangement of the component embedded substrate and another component on a mounting board; and selecting arrangement of the electrode pad on the basis of the mounting arrangement information and the pad information.

Thus, in a design support apparatus, a design support program, and a design support method of the present disclosure, the design support apparatus, the design support program, and the design support method of the disclosure are capable of optimizing arrangement of an electrode pad on a component embedded substrate while ensuring a degree of freedom of design.

### BRIEF DESCRIPTION OF THE DRAWINGS

FIG. 1 is a block diagram illustrating the configuration of a design support apparatus according to a first embodiment.

FIG. 2 is a flowchart illustrating a processing procedure of a design support method according to the first embodiment.

FIG. 3 is a view schematically illustrating one configuration of a circuit diagram according to an embodiment of the disclosure.

FIG. 4A is a schematic view illustrating a circuit database.

FIG. 4B is a schematic view illustrating a component database.

FIG. 5 is a view for schematically illustrating mounting arrangement information.

FIG. 6 is a view for schematically illustrating pad arrangement selection.

FIG. 7 is a flowchart for illustrating an example of a procedure of the pad arrangement selection.

FIG. 8 is a block diagram illustrating the configuration of a design support apparatus according to a second embodiment.

FIG. 9 is a flowchart illustrating a processing procedure of a design support method according to the second embodiment.

FIG. 10 is a flowchart illustrating a processing procedure of gate driver information acquisition.

FIG. 11 is a schematic drawing illustrating a gate driver database.

FIG. 12 is a flowchart illustrating a processing procedure of a gate driver arrangement direction setting.

FIG. 13 is a block diagram illustrating the configuration of a design support apparatus according to a third embodiment.

FIG. 14 is a flowchart illustrating a processing procedure of a design support method according to the third embodiment.

FIG. 15 is a flowchart specifically illustrating a processing procedure of area information calculation according to the third embodiment.

FIG. 16 is a flowchart specifically illustrating a processing procedure of required minimum pad area calculation according to the third embodiment.

FIG. 17 is a view schematically illustrating a simplified model applied during calculation of a junction-to-case thermal resistance according to the third embodiment.

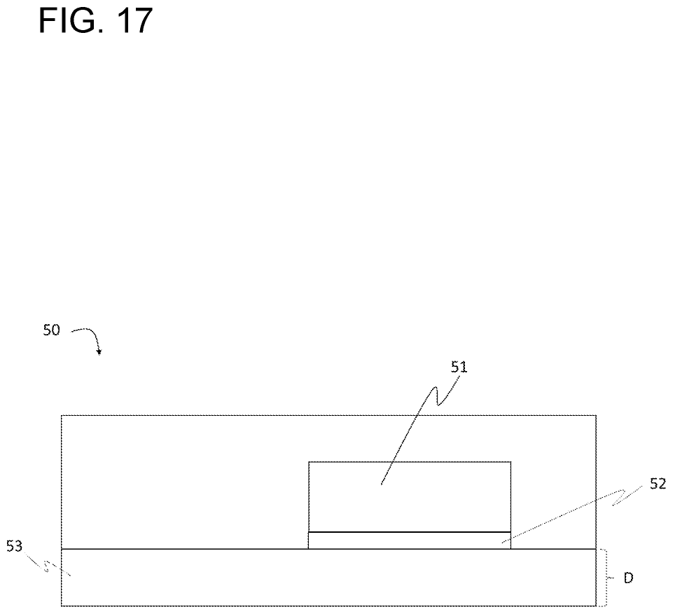

FIG. 18 is a flowchart for illustrating an example of a procedure of pad arrangement selection according to the third embodiment.

FIG. 19 is a view illustrating an example of pin arrangement of a gate driver according to the second embodiment.

FIG. 20 is a view illustrating an example of a combination of a pin number and a pin type of the gate driver according to the second embodiment.

### DETAILED DESCRIPTION

In the conventional substrate design apparatus described, a terminal of the subordinate substrate is laid out in such a manner as to achieve the shortest wiring from a terminal of the subordinate substrate determined to be arranged in advance to another component on the master substrate. Meanwhile, the conventional substrate design apparatus described does not give sufficient consideration to optimizing terminal arrangement itself of the subordinate substrate or that of a component on the subordinate substrate.

The present inventors have found that using a component embedded substrate as a subordinate substrate makes it possible to optimize pin arrangement design on a surface of the component embedded substrate on the basis of arrangement information about arrangement on a mounting board.

Embodiments of the present disclosure will be described below with reference to the accompanying drawings. In the following description, the same parts and components are designated by the same reference numerals. The present embodiment includes, for example, the following disclosures.

### Structure 1

A design support apparatus that supports design of a component embedded substrate including an embedded electronic component that configures at least a part of a circuit, the apparatus including at least: a component information acquiring unit that acquires component information containing at least component identifying information about the electronic component to be incorporated in the component embedded substrate; a pad information acquiring unit that acquires pad information about a type and the number of electrode pads to be arranged on the component embedded substrate on the basis of the component information; a mounting arrangement information acquiring unit that acquires mounting arrangement information as arrangement information about arrangement of the component embedded substrate and another component on a mounting board in which the component embedded substrate is to be incorporated; and a pad arrangement selecting unit that selects arrangement of the electrode pad on a surface of the component embedded substrate on the basis of the mounting arrangement information and the pad information.

### Structure 2

The design support apparatus according to [Structure 1], further including: a circuit component information acquiring unit that acquires information about circuit components to be included in the circuit from a circuit database containing information about a configuration of the circuit; and an incorporated component selecting unit that selects a component to be incorporated in the component embedded substrate from the circuit components, the component information acquiring unit acquiring information about an electronic component selected by the incorporated component selecting unit.

### Structure 3

The design support apparatus according to [Structure 1] or [Structure 2], wherein the pad arrangement selecting unit selects arrangement of at least a power source pad and a ground pad.

### Structure 4

The design support apparatus according to any of [Structure 1] to [Structure 3], wherein the mounting arrangement information contains at least arrangement information about arrangement of the component embedded substrate, an input terminal, an output terminal, a gate driver, and a control IC on the mounting board.

### Structure 5

The design support apparatus according to [Structure 4], wherein the mounting arrangement information contains at least information about a relative positional relationship between the component embedded substrate, the input terminal, the output terminal, the gate driver, and the control IC.

### Structure 6

The design support apparatus according to any of [Structure 1] to [Structure 5], wherein the component information acquiring unit further acquires gate driver information.

### Structure 7

The design support apparatus according to [Structure 6], further including: a gate driver arrangement direction selecting unit that selects an arrangement direction of the gate driver.

### Structure 8

The design support apparatus according to any of [Structure 1] to [Structure 7], wherein the pad arrangement selecting unit further selects arrangement of a signal pad.

### Structure 9

The design support apparatus according to any of [Structure 1] to [Structure 8], wherein the mounting arrangement information further includes geometry information containing at least information about a layer structure, a copper foil thickness, and a board material of the mounting board.

### Structure 10

The design support apparatus according to [Structure 9], further including: an area information acquiring unit that acquires a required minimum area of the electrode pad on the basis of the geometry information about the mounting board and the component information.

### Structure 11

The design support apparatus according to [Structure 10], wherein the area information acquiring unit further derives a required minimum mounting area required for embedding the electronic component in the component embedded substrate on the basis of the component information.

### Structure 12

The design support apparatus according to [Structure 10] or [Structure 11], wherein the area information acquiring unit further derives a required minimum heat dissipation area of the component embedded substrate.

### Structure 13

The design support apparatus according to any of [Structure 1] to [Structure 12], further including: an output device that outputs pad arrangement selected by the pad arrangement selecting unit.

### Structure 14

The design support apparatus according to [Structure 13], wherein the pad arrangement is displayed in a changeable form.

### Structure 15

The design support apparatus according to [Structure 14], wherein the pad arrangement is displayed together with at least the component information.

### Structure 16

A design support program that supports design of a component embedded substrate including an embedded electronic component that configures at least a part of a circuit, the program causing a computer to perform: a process of acquiring component information about the electronic component to be incorporated in the component embedded substrate; a process of acquiring pad information about a type and the number of electrode pads to be arranged on a surface of the component embedded substrate on the basis of the component information; a process of acquiring mounting arrangement information about arrangement of the component embedded substrate and another component on a mounting board; and a process of selecting arrangement of the electrode pad on the basis of the mounting arrangement information and the pad information.

### Structure 17

A design support method of supporting design of a component embedded substrate including an embedded electronic component that configures at least a part of a circuit, the method including at least: acquiring component information about the electronic component to be incorporated in the component embedded substrate; acquiring pad information about a type and the number of electrode pads to be arranged on a surface of the component embedded substrate on the basis of the component information; acquiring mounting arrangement information about arrangement of the component embedded substrate and another component on a mounting board; and selecting arrangement of the electrode pad on the basis of the mounting arrangement information and the pad information.

A design support apparatus according to an embodiment of the disclosure is a design support apparatus that supports design of a component embedded substrate including an embedded electronic component that configures at least a part of a circuit. The apparatus includes at least: a component information acquiring unit that acquires component information about the electronic component to be incorporated in the component embedded substrate; a pad information acquiring unit that acquires electrode pad information about a type and the number of electrode pads to be arranged on a surface of the component embedded substrate on the basis of the component information; a mounting arrangement information acquiring unit that acquires mounting arrangement information about arrangement of the component embedded substrate and another component on a mounting board in which the component embedded substrate is to be incorporated; and a pad arrangement selecting unit that selects arrangement of the electrode pad on the surface of the component embedded substrate on the basis of the mounting arrangement information and the pad information.

While embodiments of the design support apparatus of the disclosure will be described below using the drawings, the disclosure is not limited to these embodiments.

### First Embodiment

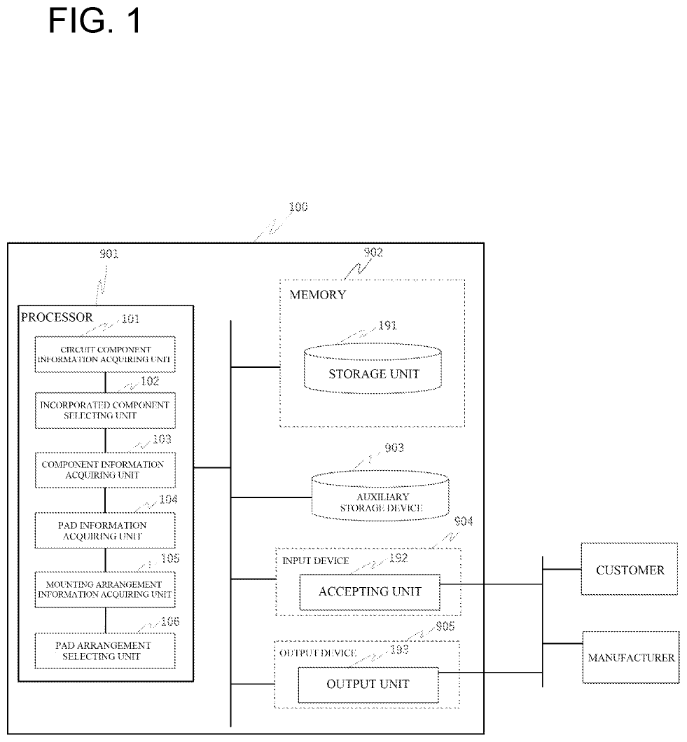

A design support apparatus 100 in FIG. 1 is a computer with hardware including a processor 901, a memory 902, an auxiliary storage device 903, an input device 904, and an output device 905. The processor 901 is connected to other hardware through a signal line.

The processor 901 is an IC (integrated circuit) that performs processing and controls the other hardware. More specifically, the processor 901 is a CPU (central processing unit), a DSP (digital signal processor), or a GPU (graphics processing unit). The memory 902 is a volatile storage device. The memory 902 is also called a main storage device or a main memory. More specifically, the memory 902 is a RAM (random access memory).

The auxiliary storage device 903 is a nonvolatile storage device. More specifically, the auxiliary storage device 903 is a ROM (read only memory) or an HDD (hard disc drive). The input device 904 is a device to accept an input. More specifically, the input device 904 is a keyboard, a mouse, a numeric keypad, or a touch panel, for example. In an embodiment of the disclosure, the input device 904 may be a device connected through a network to an external customer's terminal, for example, and may accept information input by an external designer (customer) using an accepting unit 192. The information input to the input device 904 may be supplied as digital information through a network, for example. As a more specific example, the information input to the input device 904 may be information (digital information) input from the customer's terminal and supplied through the network.

The output device 905 is a device to produce an output. More specifically, the output device 905 is a monitor to make a display or a printer to produce a print, for example. In an embodiment of the disclosure, the output device may be a device connected through a network to an external customer's terminal, for example, and may be configured in such a manner as to allow display of output information through an output unit 193 on a display of a terminal belonging to an external designer (customer), for example. The information output by the output device 905 may be supplied as digital information through a network, for example. As a more specific example, the information output by the output device 905 may be displayed through a network on a customer's terminal or on a display of a manufacturer, for example.

The design support apparatus 100 includes “units” provided as elements forming a functional configuration including a circuit component information acquiring unit 101, an incorporated component selecting unit 102, a component information acquiring unit 103, a pad information acquiring unit 104, a mounting arrangement information acquiring unit 105, and a pad arrangement selecting unit 106. The functions of the “units” are realized using software. The functions of the “units” will be described later.

The auxiliary storage device 903 stores a program for realizing the functions of the “units.” The program for realizing the functions of the “units” is loaded on the memory 902 and executed by the processor 901. The auxiliary storage device 903 further stores an OS (operating system). At least part of the OS is loaded on the memory 902 and run by the processor 901. Specifically, the processor 901 executes the program for realizing the functions of the “units” while running the OS.

Data obtained by executing the program for realizing the functions of the “units” is stored into a storage device that may be the memory 902, the auxiliary storage device 903, a register in the processor 901, or a cache memory in the processor 901. The design support apparatus 100 may include a plurality of processors 901 and these processors 901 may work together to execute the program for realizing the functions of the “units.”

The memory 902 functions as a storage unit 191 storing data. However, a storage device other than the memory 902 may function as the storage unit 191. The input device 904 functions as the accepting unit 192 that accepts an input. The output device 905 functions as the output unit 193 that produces an output.

The “units” may be read as “processes” or as “steps.” The functions of the “units” may be realized using firmware. The program for realizing the functions of the “units” may be stored into a nonvolatile storage medium such as a magnetic disk, an optical disk, or a flash memory.

The operation of the design support apparatus 100 corresponds to a design support method. A procedure of the design support method corresponds to a procedure of a design support program.

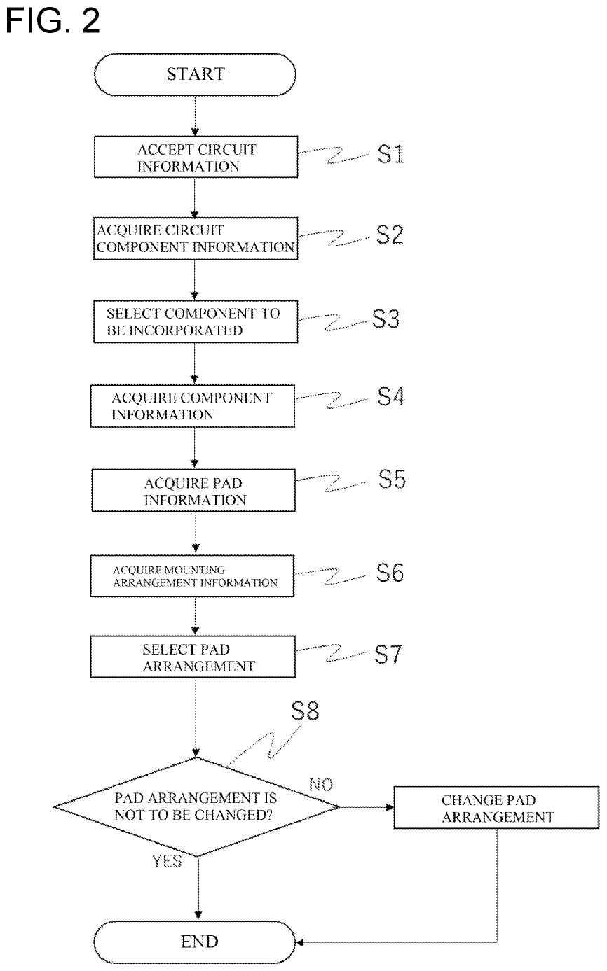

The operation of the design support apparatus 100 (design support method) will be described on the basis of FIG. 2.

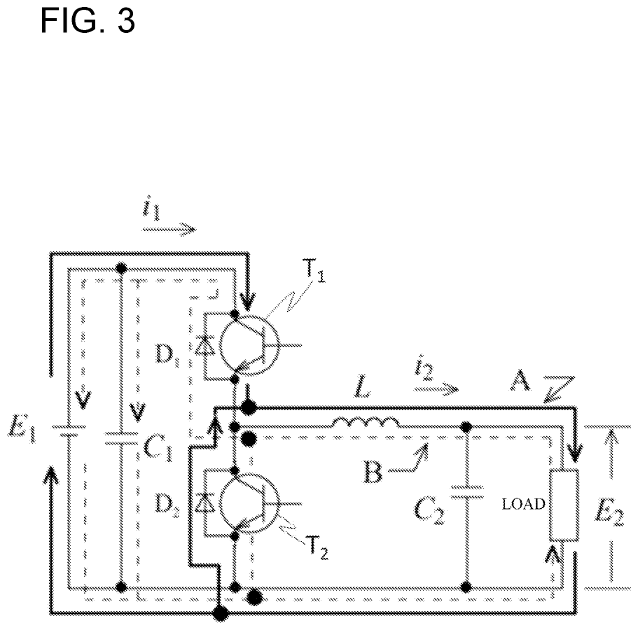

In step S1, a designer operates the input device 904 to input circuit information, and the accepting unit 192 accepts the input circuit information. In an embodiment of the disclosure, the designer (customer) may operate an external terminal to input the circuit information, and the input device 904 may acquire (accept) the input circuit information through the accepting unit 192. Specifically, the circuit information is a circuit type name and a circuit diagram, for example. Examples of the circuit type name include a half-bridge circuit, a full-bridge circuit, a boost chopper circuit, and a step-down chopper circuit. The circuit type name is not limited to these examples as long as it indicates a basic circuit configuration including at least an electronic component to be incorporated in a component embedded substrate. While the circuit diagram may be a circuit diagram illustrated in FIG. 3, for example, it is not limited to this. In an embodiment of the disclosure, it is preferable that a plurality of circuit type names and a plurality of circuit diagrams stored in advance in the storage unit 191 be displayed using the output device 905, and the customer (designer) select a circuit type name and a circuit diagram to be used from the displayed circuit type names and circuit diagrams.

In step S2, on the basis of the circuit information acquired by the input device, the circuit component information acquiring unit 101 acquires component information (circuit component information) required for the above-described circuit configuration, specifically, information about circuit components to be included in the circuit from a circuit database 210. As a specific example, the circuit component information is a component type name such as a diode, a transistor, a capacitor, or a coil. In an embodiment of the disclosure, the circuit component information may contain a netlist covering connection between circuit components. For example, information in the netlist is used in making design of a wiring in the component embedded substrate or design of a wiring on a mounting board between the component embedded substrate and a different component. In an embodiment of the disclosure, the circuit information input by the designer (customer) preferably contains information about an operating condition of the circuit (hereinafter also called “operating information”). More specifically, the operating information contains an operating condition of the circuit such as a breakdown voltage, a current value, or an operating frequency, for example. The operating information is used in acquisition of component information described later. In an embodiment of the disclosure, in step S2 in FIG. 2, information such as a value of a thermal resistance required for the component embedded substrate or an insulation structure (insulation: heat dissipation on upper surface, insulation: heat dissipation on lower surface, non-insulation: heat dissipation on upper surface, non-insulation: heat dissipation on lower surface, for example) may be input in addition to the above-described circuit information.

In step S3, the incorporated component selecting unit 102 selects a component to be incorporated in the component embedded substrate from the circuit components (constituting components of the circuit) acquired by the circuit component information acquiring unit 101. In an embodiment of the disclosure, an active component is selected as an incorporated component from the constituting components of the circuit, for example. As a more specific example, if the circuit configuration is a step-down chopper circuit and if the circuit diagram is the circuit diagram illustrated in FIG. 3, switching elements T1 and T2 as active components are selected as components to be incorporated in the component embedded substrate. Such selection may be made on the basis of the above-described criterion (whether a component is an active component) or on the basis of another criterion for selection. Specifically, in an embodiment of the disclosure, not only the active component but also a passive component may be selected as a component to be incorporated in the component embedded substrate. The above-described criterion for selection may be a criterion stored in advance in the storage unit 191. In an embodiment of the disclosure, the incorporated component selecting unit 102 may acquire incorporated component information selected and input by an external designer (customer) from the input device 904 or from an external terminal belonging to the designer (customer). In the present specification, a designer to operate the processor is called an “internal designer,” a designer to operate an external terminal connected to the design support apparatus through a network or the like is called an “external designer,” and the internal designer and the external designer are also collectively called a designer.

In step S4, the component information acquiring unit 103 acquires component identifying information (component identifier) from a component database stored in the storage unit 191 that is information corresponding to the component selected by the incorporated component selecting unit. In this step, the component information acquiring unit 103 acquires component identifying information conforming to the operating information contained in the circuit information described above input by the designer, and selects a component corresponding to the acquired component identifying information as an incorporated component. If the component identifying information conforming to the above-described operating information includes a plurality of component identifying information pieces, these pieces of component identifying information may be output together with other information about components (cost, name of manufacturer, specification) through the output device 905, and the designer may select a component to be used. The component identifying information is information identifying the incorporated component. As a more specific example, the component identifying information is a component identifier of each incorporated component (the name of the component, for example). In an embodiment of the disclosure, in addition to the component identifying information, the component information acquiring unit 103 further acquires gate driver information for specifying a recommended gate driver for a component requiring a gate driver (such as a switching element). The gate driver information contains at least gate driver identification information and pin arrangement information. Acquisition of the gate driver information will be described in more detail in a second embodiment.

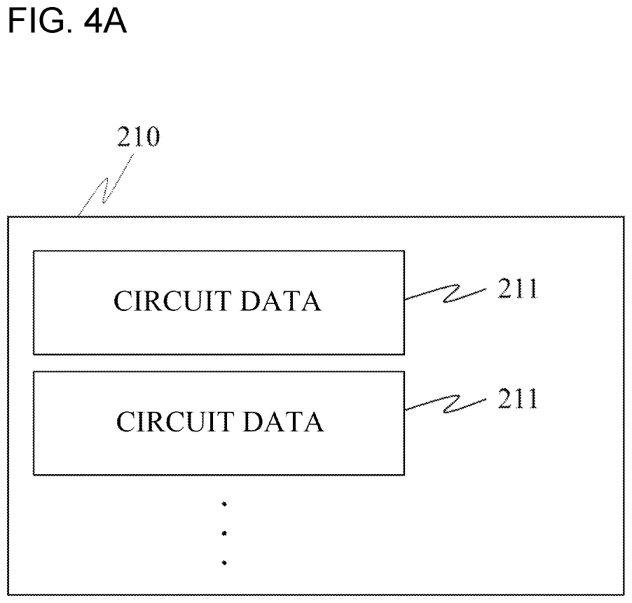

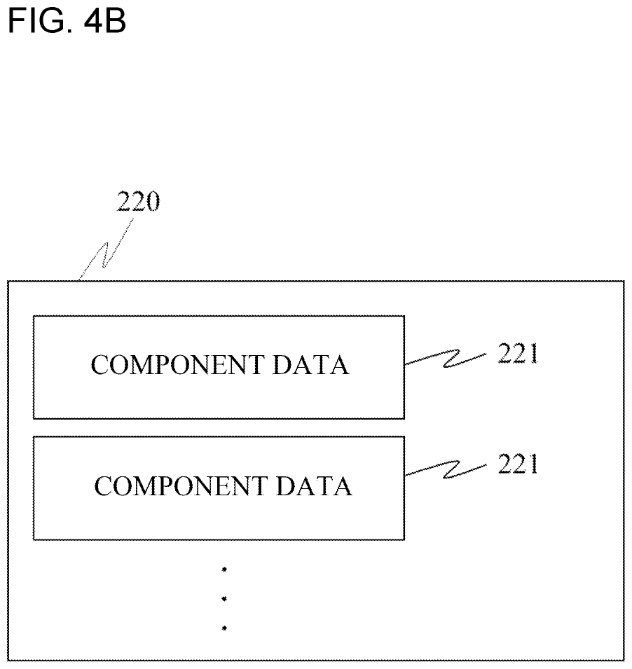

The circuit database and the component database will be described using FIGS. 4A and 4B. A circuit database 210 illustrated in FIG. 4A is a group of pieces of circuit data 211 and is stored in advance in the storage unit 191. The circuit data 211 contains information about a circuit such as a circuit type name, a circuit diagram, the type and the number of constituting components, etc. A component database 220 illustrated in FIG. 4B is a group of pieces of component data 221 and is stored in advance in the storage unit 191. The component data 221 contains information about a component provided in a general component database such as a component identifier, an outer shape of the component, electrical characteristics of the component, etc. The component identifier indicates information usable for identifying each component such as the name of the component, for example. The outer shape of the component indicates the shape and dimension of the component. In an embodiment of the disclosure, the outer shape of the component preferably contains information about the shape and dimension of the component as a bare chip. Containing such information makes it possible to make a design more smoothly in incorporating into the component embedded substrate. If the component is an IGBT, for example, the electrical characteristics of the component are information provided in a device datasheet or information about various types of performance graphs such as a collector-emitter voltage, a gate breakdown voltage, a collector current, a junction temperature, etc.

In step S5, on the basis of the component identifying information acquired by the component information acquiring unit 103, the pad information acquiring unit 104 derives a component type name and the number of components to be incorporated in the component embedded substrate, thereby acquiring pad information on the basis of the derived component type name and number. The pad information contains at least information about the type and the number of electrode pads to be arranged on a surface of the component embedded substrate. The pad information is generally determined uniquely by the type name and the number of components to be incorporated in the component embedded substrate. Preferably, a combination of the type name and the number of the components with the type and the number of the pads is stored in advance in the storage unit 191. Table 1 illustrates an example of the combination of the type name and the number of the components with the pad information.

TABLE 1

| Component | | |
|---|---|---|
| type name | Number | Pad information |
| IGBT | 2 | Power source pad (input pad) × 1, |
| | | Power source pad (output pad) × 1, |
| | | Ground pad × 1, Signal pad × 4 |

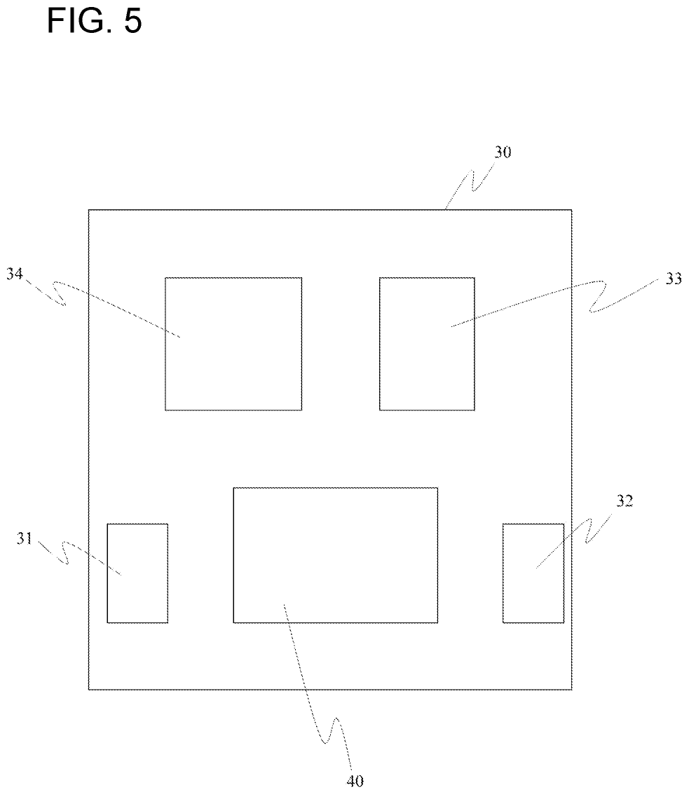

In step S6, the mounting arrangement information acquiring unit 105 acquires mounting arrangement information applied in arranging the component embedded substrate on a mounting board. The mounting arrangement information is arrangement information about arrangement of the component embedded substrate and a component other than the component embedded substrate and to be incorporated on the mounting board (hereinafter also called a “mounted component”) on the mounting board. The mounting arrangement information may be input by an internal designer (customer) while the internal designer operates the input device 904. In an embodiment of the disclosure, it is preferable that an external designer (customer) input the mounting arrangement information while operating an external terminal, and the input device 904 acquire the mounting arrangement information as digital data through a network. This preferable configuration makes it possible to more efficiently select pad arrangement conforming to mounting arrangement on a customer side. FIG. 5 is a schematic view (top view) for illustrating the mounting arrangement information. FIG. 5 illustrates a mounting board 30 on which a component embedded substrate 40, an input terminal 31, an output terminal 32, a gate driver 33, and a control IC 34 are incorporated as mounted components. In an embodiment of the disclosure, the mounting arrangement information is not particularly limited as long as it provides at least a relative positional relationship between the components (component embedded substrate 40, input terminal 31, output terminal 32, gate driver 33, and control IC 34) to be incorporated on the mounted board. The components to be incorporated on the mounting board are not limited to the examples illustrated in FIG. 5. In an embodiment of the disclosure, the mounting arrangement information preferably contains information about the shape and size of each component. In addition to the information about the shape and the size, the mounting arrangement information may further contain information about an arrangement coordinate of each component from a particular reference point. In an embodiment of the disclosure, the mounting arrangement information may be drawing information or CAD information resulting from operation and/or input by an external designer (customer) using an external terminal. In an embodiment of the disclosure, the mounting arrangement information preferably contains information about a terminal of each component other than the component embedded substrate and to be arranged on the mounting board, more preferably, contains a netlist relating to information about connection between such terminals.

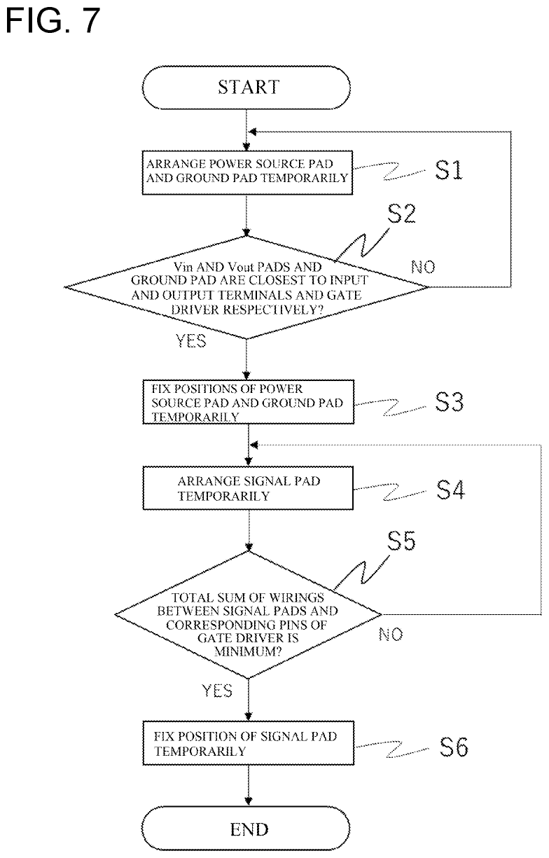

Next, in step S7, on the basis of the mounting arrangement information, the pad arrangement selecting unit 106 selects arrangement of each electrode pad (this may also be called a “pad” simply) on the component embedded substrate. In the present embodiment, while the size of each electrode pad is output as a size temporarily set in indicating result of the pad arrangement selection, it is finally determined by giving consideration to a thermal or electrical condition. In the present embodiment, a required size of the component embedded substrate may be designed while consideration is given to the size and arrangement of each of the electrode pads. In the present embodiment, the pad arrangement selecting unit 106 selects arrangement of at least power source pads (Vin and Vout) and a ground pad. After the arrangement of these power source pads and ground pad is selected, arrangement of a signal pad is preferably selected. While an example of a processing procedure taken by the pad arrangement selecting unit 106 in selecting pad arrangement is described using FIG. 7, the disclosure is not limited to this. In step S1 in FIG. 7, the power source pads (Vin pad and Vout pad) and the ground pad are arranged temporarily. A method of the temporary arrangement may be a manual method or an automatic method. A method of making the temporary arrangement automatically is not particularly limited but may be a publicly-known method unless it interferes with the present disclosure. Examples of the method of making the temporary arrangement automatically include a centroid method and a mini-cut method. In making the temporary arrangement, it is preferable that the shape and size of each of the electrode pads and a spacing distance between the electrode pads be set temporarily. The spacing distance means a certain distance to be provided between pads and to be set in view of a degree of contamination or a required breakdown voltage. The temporary set value described above is stored in advance in storage means such as the storage unit 191.

In step S2 in FIG. 7, it is judged whether the temporarily arranged power source pads (Vin and Vout) and the ground pad are arranged closest to the input terminal, the output terminal, and the gate driver respectively in this order. If it is determined as a result of the judgment that these three pads (Vin pad, Vout pad, and ground pad) are arranged closest to the input terminal, the output terminal, and the gate driver on the mounting board respectively relative to each other, the positions of these three pads are fixed temporarily as step S3 (step S3). If these three pads are not arranged closest to the respective three components relative to each other, temporary arrangement is made again. A criterion for the judgment (whether the Vin pad is closest to the input terminal than the other terminals, whether the Vout pad is closest to the output terminal than the other terminals, and whether the ground pad is closest to the gate driver than the other terminals) is not limited to that described above but may be a different judgment criterion.

A method of temporarily arranging the power source pads and the ground pad is not limited to the above-described method but may be a different publicly-known method. As an example, the different method of the temporary arrangement is a method using calculation of an open algorithm for a packing problem. Specifically, the open algorithm is a BLF (Bottom-Left-Fill) method, for example.

Next in step S4 in FIG. 7, arrangement of the signal pad is selected. After temporary arrangement of the signal pad, it is judged in step S5 in FIG. 7 whether a total sum of wirings between signal pads and corresponding pins of a gate driver is minimum. The temporary arrangement of the signal pads and the judgment are made according to a following procedure, for example. However, the disclosure is not limited to this procedure.

First, on the basis of the arrangement information about the power source pads and the ground pad temporarily fixed in step S3 in FIG. 7, an arrangement available region of the signal pad (including information about the position and dimension of a pad arrangement available region) is specified. The signal pad arrangement available region is a region determined by subtracting the arrangement region of the power source pads and the ground pad temporarily fixed in step S3 in FIG. 7 from a pad arrangement available region on the component embedded substrate temporarily set in advance. Next, in steps S4 and S5 in FIG. 7, the signal pads are temporarily arranged in the signal pad arrangement available region (temporary arrangement 1). At this time, a total sum of wirings (wiring total sum 1) between all the signal pads and the corresponding pins of the gate driver in the temporary arrangement 1 is derived. Next, assumed temporary arrangements of the signal pads other than the temporary arrangement 1 are made (temporary arrangements 2), and wiring total sums according to the temporary arrangements 2 are derived. In this way, all the wiring total sums corresponding to a combination of the thinkable temporary arrangements of the signal pads other than the temporary arrangement 1 are derived, and it is judged whether the wiring total sum 1 is minimum by comparing the wiring total sum 1 with the wiring total sums thereby derived. An automatic wiring process such as a line search process or a maze process is applicable to a wiring process used in deriving the wiring total sum. If the total sum of the wirings between the signal pads and the corresponding pins of the gate driver is not minimum, temporary arrangement of the signal pads is made again. This operation is performed repeatedly, and if the wiring total sum is confirmed to be minimum, pad arrangement is temporary fixed (step S6). Reason for this temporary fixing is that there is a possibility that a designer will change arrangement of each pad in outputting pad arrangement described later. Net information about a net between the pins of the gate driver and the signal pads to be used may be information contained in the above-described mounting arrangement information or information stored in advance in the storage unit 191.

The judgment in step S5 in FIG. 7 described above may be made under a criterion whether a total sum of the wirings between the signal pads and the corresponding pins of the gate driver is equal to or less than a certain reference value, for example. In this case, the reference value may be a value stored in advance in the storage unit 191, or may be a value input by a designer (customer) through the input device 904 or through an external customer's terminal connected to the input device 904 through a network.

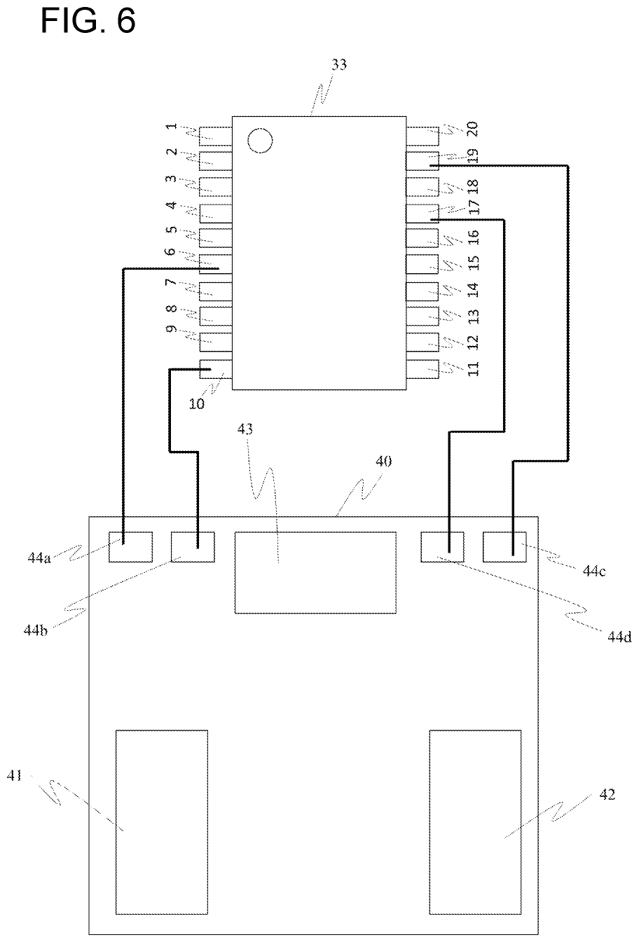

The selected pad arrangement is output using the output unit 193 in a form of a drawing such as that illustrated in FIG. 6, for example. In an embodiment of the disclosure, the selected pad arrangement is preferably displayed from the output unit 193 through a network on a display of an external terminal belonging to a customer, for example. In an embodiment of the disclosure, the pad arrangement is also preferably displayed together with the above-described component information. This preferable configuration allows a designer (customer) to judge the competence of the pad arrangement while giving consideration further to the component information, making it possible to proceed further in design more efficiently.

In step S8 in FIG. 2, a customer (external designer, for example) determines whether to change the pad arrangement. If the pad arrangement is to be changed, the customer inputs a substance of the change. The change in the pad arrangement may be change in a connection between the pin belonging to the gate driver and the pad belonging to the component embedded substrate, or may be change in the position of the pad on the surface of the component embedded substrate. While not illustrated in FIG. 2, after such change is accepted, the judgments in steps S2 and S5 in FIG. 7 may be made and result of the judgments may be displayed from the output unit 193 on a display of an external terminal belonging to the customer, for example. In response to the judgment result, the pad arrangement is further adjusted repeatedly on the customer side to determine pad arrangement finally.

The details of the steps and the order of implementation of the steps in the present embodiment are given merely as examples and the disclosure is not limited to the examples given above. This also applies to embodiments described below.

As described above, according to the present embodiment, it is possible to optimize arrangement of each electrode pad to be incorporated on a surface of a component embedded substrate while consideration is given further to arrangement on a mounting board.

### Second Embodiment

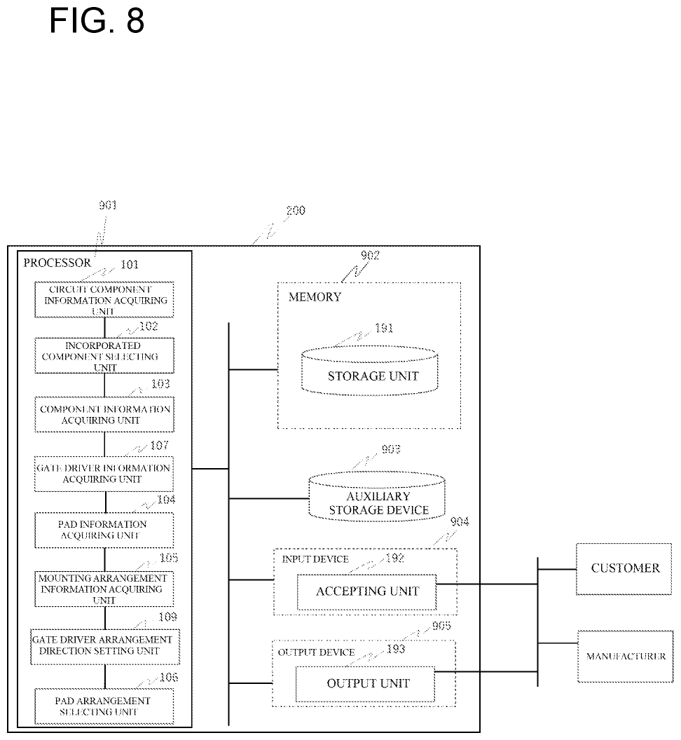

FIG. 8 is a block diagram illustrating the configuration of a design support apparatus according to a second embodiment of the disclosure. A unit corresponding to that of the first embodiment is given the same sign. A unit functioning in the same way as in the first embodiment will not be described. The design support apparatus illustrated in FIG. 8 differs from the design support apparatus in FIG. 1 in that a gate driver information acquiring unit 107 and a gate driver arrangement direction setting unit 109 are illustrated clearly. The design support apparatus in FIG. 1 may also acquire gate driver information and a gate driver arrangement direction as information contained in mounting arrangement information. In the present embodiment, acquisition of such gate driver information and setting of such a gate driver arrangement direction will be described in more detail.

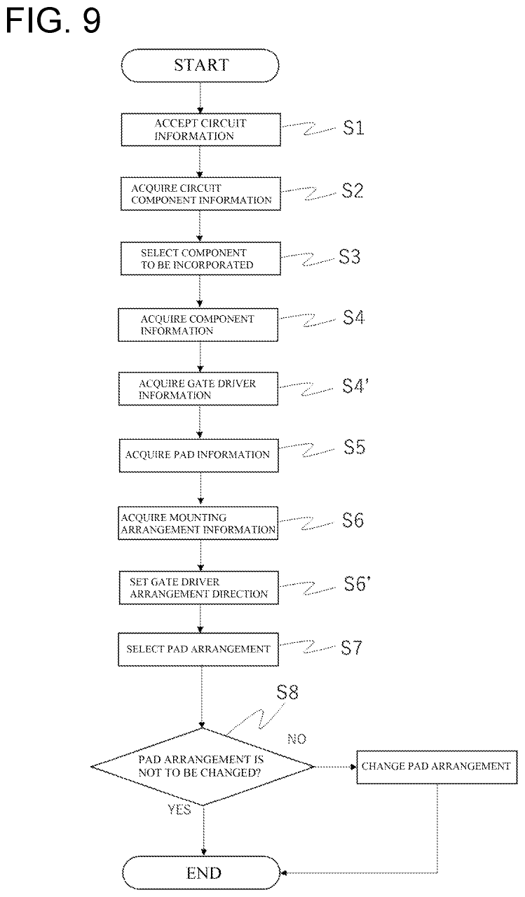

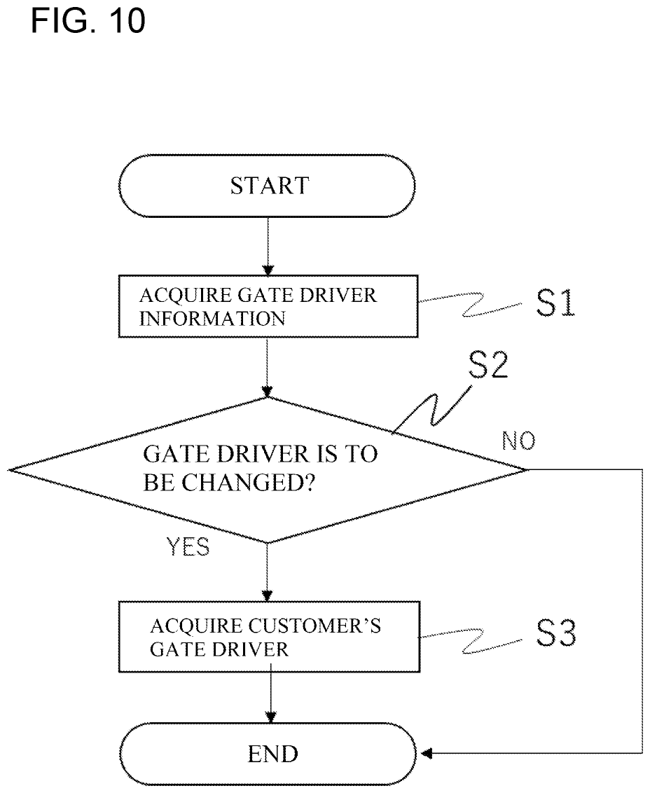

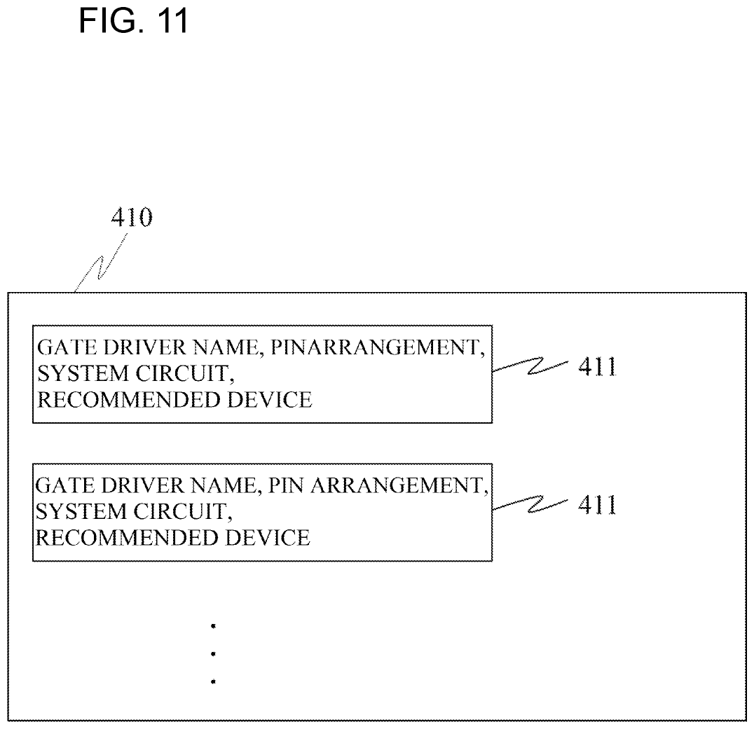

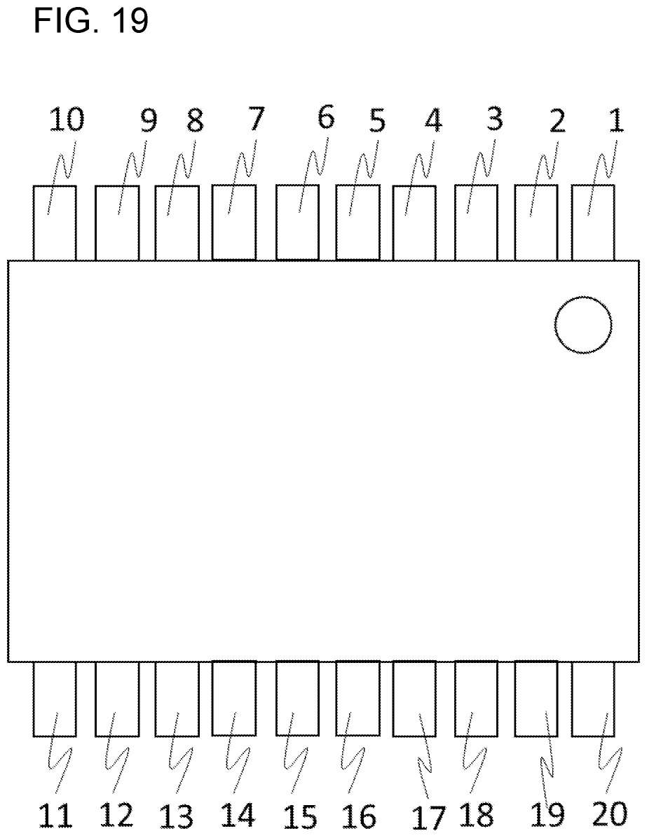

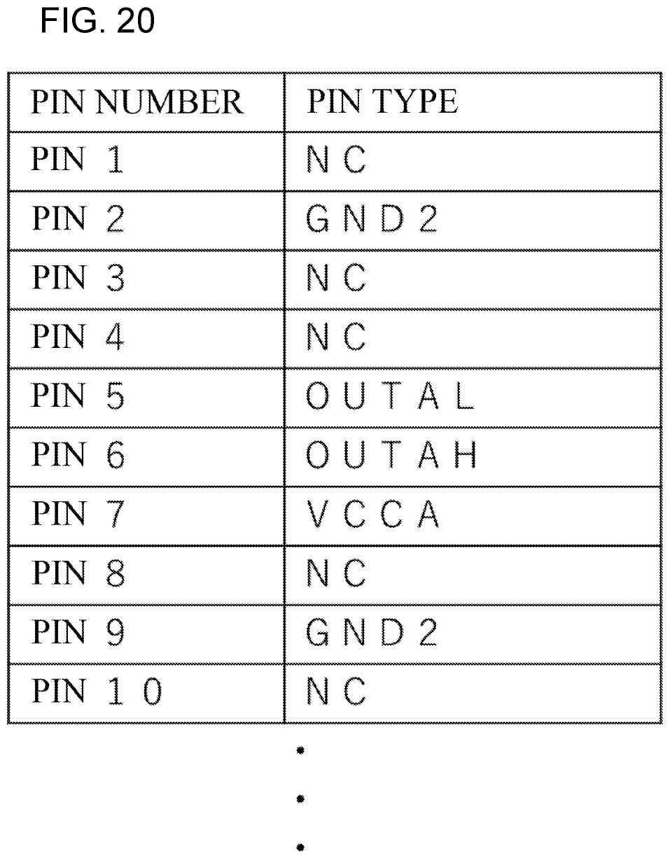

The operation of a design support apparatus 200 (design support method) according to the second embodiment of the disclosure will be described using FIGS. 9 to 12. A processing flow of the design support method according to the present embodiment is the same as that of the first embodiment except step S4′ and step S6′ in FIG. 9. Acquisition of gate driver information in step S4′ in FIG. 9 will be described in more detail using FIG. 10. In S1 in FIG. 10, on the basis of component identifying information acquired by the component information acquiring unit 103, recommended gate driver information is acquired from a gate driver database stored in the storage unit 191. The gate driver database is described here using FIG. 11. A gate driver database 410 illustrated in FIG. 11 is a group of pieces of gate driver data 411 and is stored in advance in the storage unit 191. The gate driver data 411 contains information in a datasheet of a gate driver such as gate driver identifying information, pin arrangement information, and system circuit information, and additionally contains recommended device information. As a more specific example, the recommended device information is a list, for example, showing gate driver identifying information recommended for each component that belongs to components stored in the component database and requires a gate driver (such as MOSFET or IGBT). The pin arrangement information is information about the type and arrangement of a pin of a gate driver such as that illustrated in FIG. 19, for example. An example of information about pin types corresponding to pin numbers (from 1 to 20 in FIG. 19) is illustrated in FIG. 20.

The acquired gate driver information is displayed from the output unit 193 on a display of an external terminal belonging to a customer through a network, for example. Here, in step S2 in FIG. 10, it is judged whether the customer (designer) is allowed to use the displayed gate driver. If the displayed gate driver is not available for use or if the designer (customer) wants to use a different gate driver, information about the different gate driver is input through an external terminal belonging to the designer (customer) or through the input device 904 as step S3 in FIG. 10. The accepting unit 192 in FIG. 8 accepts the input information about the different gate driver. In step S2 in FIG. 10, if the displayed gate driver is to be used (if the gate driver is not to be changed), a gate driver corresponding to the gate driver information acquired in step S1 in FIG. 10 is set as a gate driver to be used.

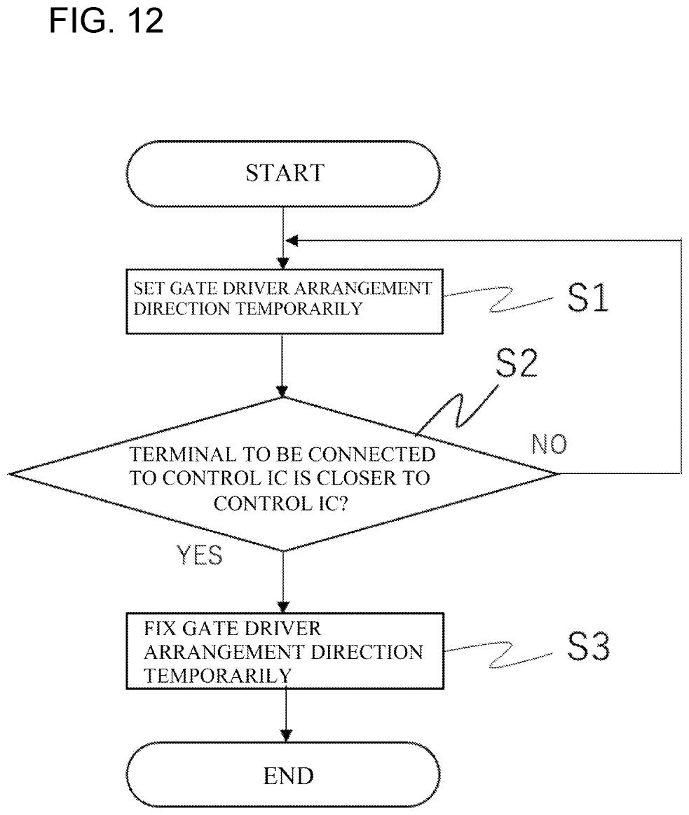

In step S6′ in FIG. 9, the gate driver arrangement direction setting unit 109 sets an arrangement direction of the gate driver on the basis of mounting arrangement information acquired by the mounting arrangement information acquiring unit 105 and the gate driver information acquired in step S4′ in FIG. 9. A processing procedure of setting of the gate driver arrangement direction will be described in more detail using FIG. 12. In step S1 in FIG. 12, an arrangement direction of the gate driver is set temporarily. After the temporary setting, it is judged on the basis of a gate driver arrangement direction rule whether the set arrangement direction is proper in step S2 in FIG. 12. The gate driver arrangement direction rule is the least rule to be fulfilled in setting an arrangement direction of the gate driver, and is preferably stored in advance in the storage unit 191.

In FIG. 12, a judgment is made on the basis of whether a terminal to be connected to a control IC is located closer to the control IC as the gate driver arrangement direction rule. The gate driver arrangement direction rule is not limited to that illustrated in step S2 in FIG. 12. If the gate driver arrangement direction rule is fulfilled in step S2 in FIG. 12, the temporary setting of the gate driver arrangement direction is completed as step S3 in FIG. 12. If the gate driver arrangement direction rule is not fulfilled in step S2 in FIG. 12, the flow returns to step S1 in FIG. 12 and an arrangement direction is temporarily set again. The arrangement direction of the gate driver set by the processing procedure in FIG. 12 is displayed together with display of pad arrangement such as that illustrated in FIG. 6, for example. During pad arrangement selection in step S7 in FIG. 9, pad arrangement on a surface of a component embedded substrate is selected using the set arrangement direction of the gate driver as one of preconditions.

The gate driver information and the information about the arrangement direction of the gate driver described above are used as conditional information in determining a total sum of wirings between signal pads and corresponding pins of the gate driver during selection of pad arrangement by the pad arrangement selecting unit 106 described in the first embodiment.

As described above, according to the present embodiment, it is possible to set an appropriate arrangement direction of a gate driver at an early stage and to optimize pad arrangement on a component embedded substrate while consideration is given to the arrangement direction of the gate driver.

### Third Embodiment

A third embodiment of the disclosure will be described below by referring to the drawings. Description to overlap the one given in the first or second embodiment will be omitted or simplified.

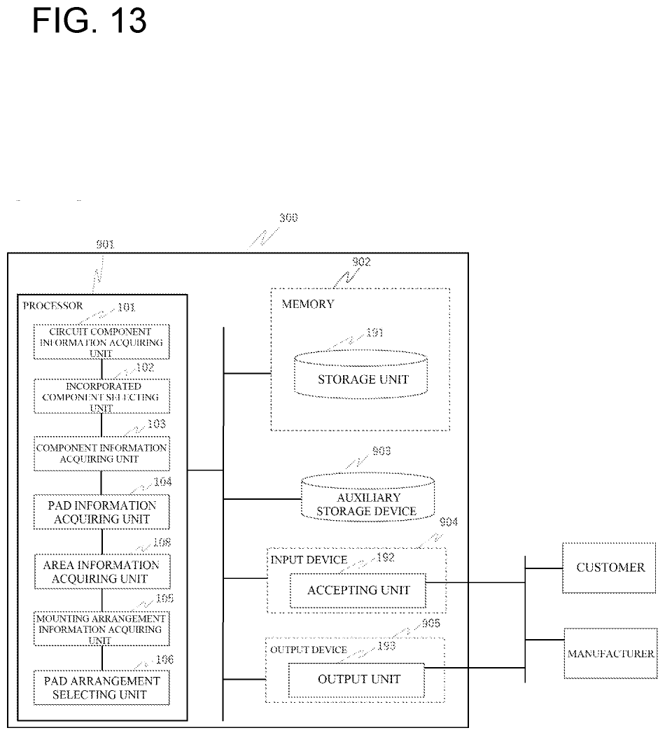

FIG. 13 is a block diagram illustrating the configuration of a design support apparatus according to the third embodiment of the disclosure. A unit corresponding to that of the first or second embodiment is given the same sign. A unit functioning in the same way as in the first or second embodiment will not be described. The design support apparatus illustrated in FIG. 13 differs from the design support apparatus in each of FIGS. 1 and 8 in that an area information acquiring unit 108 is further provided.

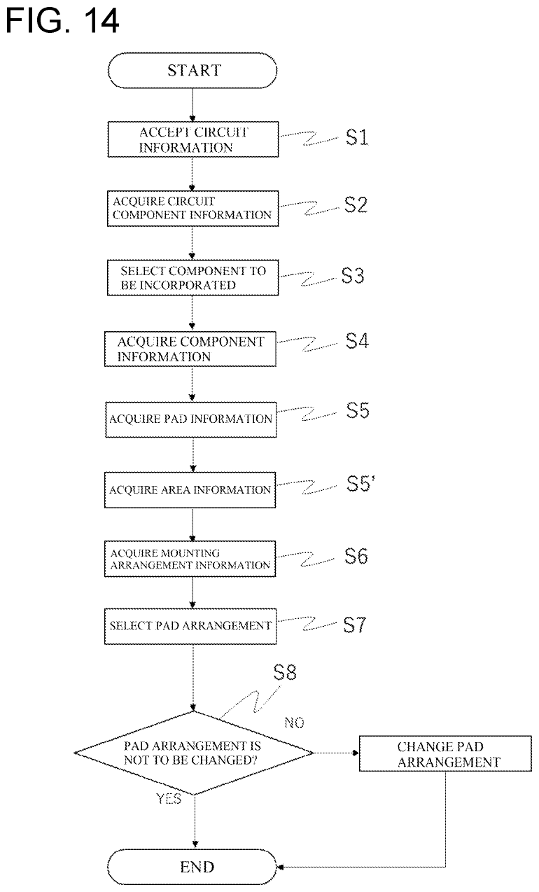

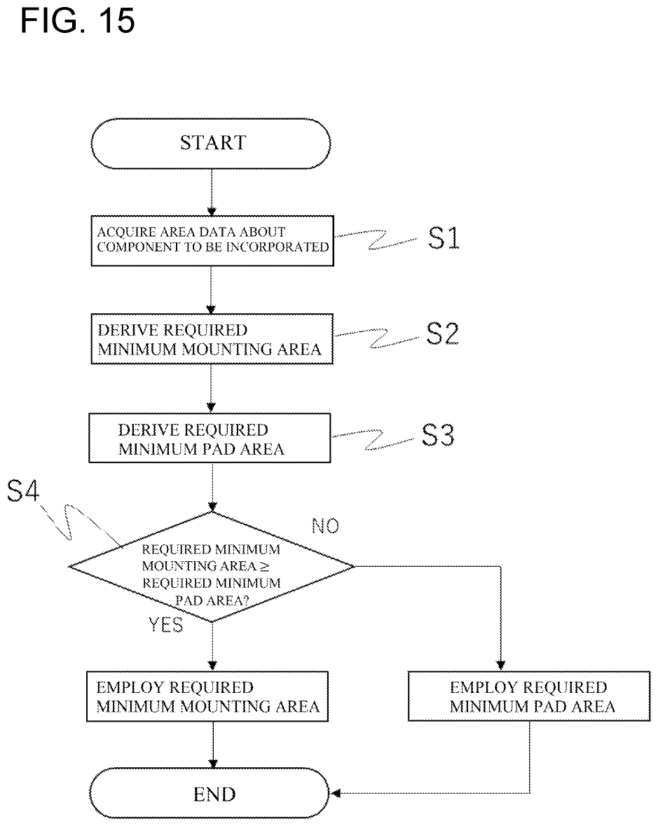

The operation of a design support apparatus 300 (design support method) according to the third embodiment of the disclosure will be described using FIG. 14. A processing flow of the design support method according to the present embodiment is the same as that of the first embodiment except step S5′ in FIG. 14. In step S5′ in FIG. 14, the area information acquiring unit 108 derives a required minimum area (area information) on a surface of a component embedded substrate on the basis of a required minimum mounting area and a required minimum pad area. A processing procedure of acquisition of the area information by the area information acquiring unit 108 will be described in more detail using FIG. 15. In step S1 in FIG. 15, area data about each electronic component to be incorporated in the component embedded substrate is acquired from the component database illustrated in FIG. 4B. Next, in step S2 in FIG. 15, on the basis of the acquired area data about each electronic component, a required minimum mounting area of the component embedded substrate is calculated. The required minimum mounting area is a minimum area of the surface of the component embedded substrate required for embedding a corresponding electronic component. The required minimum mounting area is calculated by multiplying a total of the acquired area data about each electronic component described above by a mounting factor. The mounting factor mentioned herein is a factor for setting a mounting area while consideration is given to a through hole forming region, a spacing distance between components, etc. relating to preparation of the component embedded substrate. The mounting factor is stored in advance in the storage unit 191 as a table indicating correspondence between the number of embedded components and the mounting factor, for example. The mounting area is the area of a region surrounded by a rectangular outer periphery of the component embedded substrate 40 in FIG. 6, for example.

In the present embodiment, geometry information about the component embedded substrate is preferably acquired in step S5′ in FIG. 14. The geometry information about the component embedded substrate means information such as the number of layers in the component embedded substrate, a material of a conductive layer, a material of an insulating layer, and specifications of a heat dissipation plate, etc. Preferably, the geometry information about the component embedded substrate is prepared in advance as a database in association with the type and the number of components to be incorporated, etc. The geometry information is used in extracting a permissible value for temperature increase in an electrode pad described later.

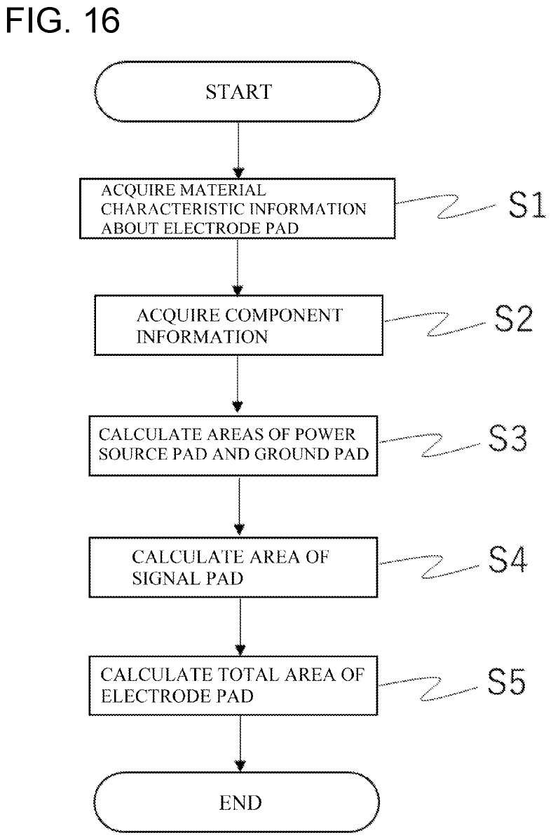

Next, in step S3 in FIG. 15, a required minimum pad area is derived. The required minimum pad area is derived by adding respective required minimum areas of all pads (power source pad, ground pad, and signal pad). The required minimum pad area is derived using publicly-known calculation means on the basis of pad information (including the type and the number of pads) acquired by the pad information acquiring unit 104 in FIG. 13, component information (including a flowing maximum current value of a component), etc. acquired by the component information acquiring unit 103 in FIG. 13. While an example of a procedure of deriving the required minimum pad area will be described using FIG. 16, the procedure in FIG. 16 is given as an example and the disclosure is not limited to this.

In step S1 in FIG. 16, material characteristic information about an electrode pad is acquired from an electrode pad database stored in the storage unit 191. The material characteristic information about the electrode pad contains at least information about a sheet resistance Rₛₑ and a sheet thermal resistance Rₛₜ in the electrode pad. A value of the sheet thermal resistance Rₛₜ is derived on the basis of a list of sheet thermal resistances of electrode pads defined in advance for each mounting configuration and information about a mounting configuration input by a designer (customer), for example. More specifically, on the basis of the information about the mounting configuration input by the designer and by referring to a list containing information about a combination of a mounting configuration and a sheet thermal resistance in an electrode pad stored in advance in the storage unit 191, the sheet thermal resistance in the electrode pad corresponding to this mounting configuration is extracted. Here, information about the mounting configuration (geometry information) is information containing at least a layer structure, a copper foil thickness, and a board material of a mounting board. Table 2 illustrates an example of the information about the mounting configuration input by the designer (customer). The electrode pad database is preferably stored in advance in the storage unit 191.

TABLE 2

| Item | Detail |
|---|---|
| Layer structure | First layer, second layer, . . . |
| Copper foil thickness | First layer: 0.035 mm, . . . |
| Material | FR4 |

Next, in step S2 in FIG. 16, component information is acquired from the component database in the storage unit 191. As the component information to be acquired, at least a value of a maximum current value I_{F} of a corresponding electronic component in a circuit is included. In step S3 in FIG. 16, the area of a power source pad (including Vin pad and Vout pad) and that of a ground pad are calculated. Step S3 will be described in detail below.

In step S3 in FIG. 16, a permissible value for temperature increase in the electrode pad is extracted first. A value input by the designer using the input device 904 may be used as the permissible value for temperature increase in the electrode pad. Alternatively, the permissible value may be extracted by referring to a value stored in advance in the storage unit 191 in combination with the configuration of the component embedded substrate. Next, on the basis of the material characteristic information (sheet resistance, sheet thermal resistance) about the electrode pad and the component information (flowing maximum current) acquired in step S1 and step S2 in FIG. 16 respectively and the acquired permissible value for temperature increase in the electrode pad described above, a required minimum area is calculated for the electrode pad (including power source pad and ground pad) using a formula (1) and a formula (2) given below. In the present embodiment, it is assumed that the area of the power source pad (each of Vin pad and Vout pad) and that of the ground pad are equal to each other. Accordingly, the required minimum area of the power source pad and the ground pad is obtained by multiplying an area determined by using the formula (1) and the formula (2) given below by the number of the power source pads and the ground pads. In an embodiment of the disclosure, if the power source pad includes the Vin pad and the Vout pad and one ground pad is used, for example, this number is “3.”

$$[ Formula 1 ]$$

$$Δ T = {R}_{se} \times S \times {I}_{f}^{2} \times {R}_{st} \times S \qquad ( 1 )$$

[In this formula, ΔT indicates a permissible value for temperature increase in the electrode pad, Rₛₑ indicates a sheet resistance, S indicates the area of the electrode pad, I_{f} indicates a flowing maximum current, and Rₛₜ indicates a sheet thermal resistance.]

$$[ Formula 2 ]$$

$$S = \sqrt{\frac{Δ T}{{R}_{se} \times {I}_{f}^{2} \times {R}_{st}}} \qquad ( 2 )$$

Next, in step S4 in FIG. 16, the area of a signal pad is acquired. In an embodiment of the disclosure, on the assumption that the area of the signal pad is determined according to a manufacturing condition, an area of one signal pad is preferably stored in advance into the storage unit 191. Accordingly, in step S4 in FIG. 16, the area of the signal pad is calculated by multiplying an area of one signal pad by the number of signal pads.

Finally, in step S5 in FIG. 16, the area of the power source pad and that of the ground pad calculated in step S3 in FIG. 16 and the area of the signal pad calculated in step S4 in FIG. 16 are added to each other to derive a required minimum pad area. The required minimum pad area is derived by further making multiplication by a factor defined by giving consideration to a spacing distance between the electrode pads. This factor is stored in advance in the storage unit 191.

The processing procedure in FIG. 15 will be described again. As described above using FIG. 16, after calculation of the required minimum pad area, the required minimum mounting area and the required minimum pad area are compared to each other in step S4 in FIG. 15 and an area determined to be larger is temporarily set as a required minimum area of the component embedded substrate.

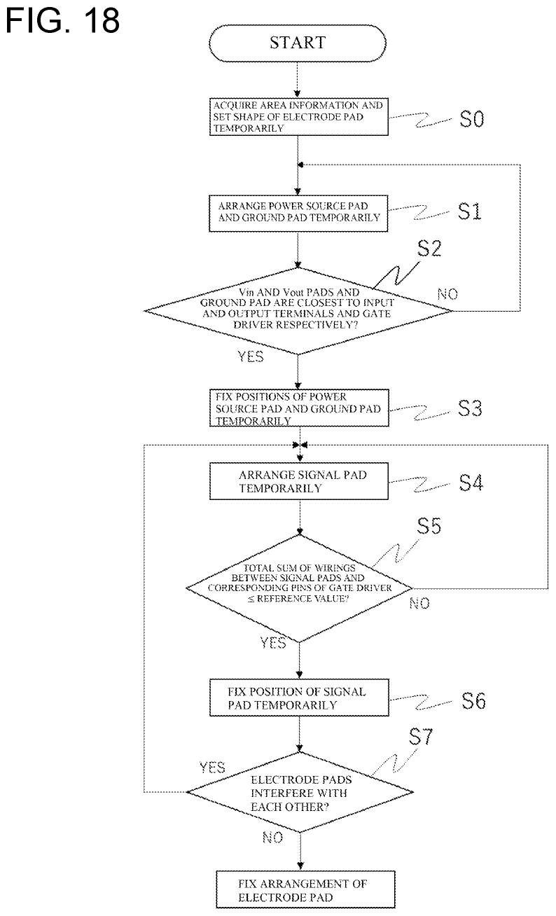

FIG. 14 will be referred to again for description of step S7. In step S7 in FIG. 14, on the basis of the area information (the required minimum area of the component embedded substrate and the area of each pad) and mounting arrangement information, pad arrangement is selected by following a processing procedure illustrated in FIG. 18. The processing procedure illustrated in FIG. 18 differs from the processing procedure illustrated in FIG. 7 in that area information is acquired and the shape of an electrode pad is set temporarily in step S0 and that electrode pad interference check is made in step S7. In step S0 in FIG. 18, the area information (the required minimum area of the component embedded substrate and the area of each pad) acquired in step S5′ in FIG. 14 is acquired. In step S0, the shape of each electrode pad is set temporarily on the basis of the acquired area information about the electrode pad. In step S7 in FIG. 18, on the basis of the area information about each electrode pad and information about the shape thereby acquired, check is made to see whether the electrode pads having been fixed temporarily in the flow until step S6 do not interfere with each other. Such an interference check unit (function) belongs to the pad arrangement selecting unit 106. If electrode pads in one set interfere with each other in step S7, the flow returns to the temporary arrangement of a signal pad in step S4 and the processes in step S4 and in its subsequent steps are performed again. The interference check in step S7 is made while consideration is given to a spacing distance between pads set in advance. If there are no electrode pads to interfere with each other in the interference check in step S7, pad arrangement selection is completed by ending up with the arrangement of each electrode pad fixed temporarily in the flow until step S6. Regarding the details in step S7, the foregoing procedure is described as an example and the disclosure is not limited to this. For example, a procedure may also be such that, in automatically arranging electrode pads in step S1 or step S3 in FIG. 18, the electrode pads are arranged temporarily in such a manner as to avoid interference between the electrode pads on the basis of information about the area and shape of each electrode pad.

After the pad arrangement is selected in step S7 in FIG. 14, the designer (customer) makes final check in step S8 in FIG. 14 to see whether the pad arrangement is not to be changed. At this time, the pad arrangement selected in step S7 is displayed on the output device 905 or on a display of an external terminal belonging to the customer in a similar style to that in FIG. 6, for example. If the designer (customer) judges that no change is to be made, the design is completed. If the designer (customer) judges that change is to be made, the pad arrangement is changed as appropriate, and then the design is completed.

As described above, according to the present embodiment, it is possible to optimize pad arrangement while consideration is given to a required minimum area of a component embedded substrate and the area of an electrode pad.

According to the embodiments, the function of the design support apparatus 100, 200, or 300 may be realized using hardware. Specifically, the design support apparatus 100, 200, or 300 may include one or two or more processing circuits and the processing circuit may realize the functions of the “units.” The design support apparatus 100, 200, or 300 may be realized using a combination of software and hardware. Specifically, some of the “units” may be realized using software, and the other “units” may be realized using hardware.

Some or all of a plurality of the embodiments described above according to the disclosure may certainly be combined, or some of the constituting elements may certainly be applied to the other embodiment. Such a configuration also belongs to an embodiment of the disclosure.

### INDUSTRIAL APPLICABILITY

The design support apparatus, the design support program, and the design support method of the disclosure are available in any field including semiconductors (such as compound semiconductor electronic devices, for example), electronic components, electric equipment components, optical electrophotographic related apparatuses, and industrial members, and especially useful for electronic component embedded substrates with embedded power devices.

The embodiments of the present invention are exemplified in all respects, and the scope of the present invention includes all modifications within the meaning and scope equivalent to the scope of claims.

### REFERENCE SIGNS LIST

30 Mounting board
31 Input terminal
32 Output terminal
33 Gate driver
34 Control IC
40 Component embedded substrate
41 Power source pad (input pad)
42 Power source pad (output pad)
43 Ground pad
44a Signal pad
44b Signal pad
44c Signal pad
44d Signal pad
50 Component embedded substrate
51 Chip
52 Die bonding material
53 Heat dissipation plate
101 Circuit component information acquiring unit
102 Incorporated component selecting unit
103 Component information acquiring unit
104 Pad information acquiring unit
105 Mounting arrangement information acquiring unit
106 Pad arrangement selecting unit
107 Gate driver information acquiring unit
108 Area information acquiring unit
109 Gate driver arrangement direction setting unit
191 Storage unit
192 Accepting unit
193 Output unit
200 Design support apparatus
210 Circuit database
211 Circuit data
220 Component database
221 Component data
300 Design support apparatus
410 Gate driver database
411 Gate driver data
901 Processor
902 Memory
903 Auxiliary storage device
904 Input device
905 Output device

1. A design support apparatus that supports design of a component embedded substrate including an embedded electronic component that configures at least a part of a circuit, the apparatus comprising at least:
a component information acquiring unit that acquires component information containing at least component identifying information about the electronic component to be incorporated in the component embedded substrate;
a pad information acquiring unit that acquires pad information about a type and the number of electrode pads to be arranged on the component embedded substrate on the basis of the component information;
a mounting arrangement information acquiring unit that acquires mounting arrangement information as arrangement information about arrangement of the component embedded substrate and another component on a mounting board in which the component embedded substrate is to be incorporated; and
a pad arrangement selecting unit that selects arrangement of the electrode pad on a surface of the component embedded substrate on the basis of the mounting arrangement information and the pad information.

2. The design support apparatus according to claim 1, further comprising:
a circuit component information acquiring unit that acquires information about circuit components to be included in the circuit from a circuit database containing information about a configuration of the circuit; and
an incorporated component selecting unit that selects a component to be incorporated in the component embedded substrate from the circuit components,
the component information acquiring unit acquiring information about an electronic component selected by the incorporated component selecting unit.

3. The design support apparatus according to claim 1, wherein
the pad arrangement selecting unit selects arrangement of at least a power source pad and a ground pad.

4. The design support apparatus according to claim 1, wherein
the mounting arrangement information contains at least arrangement information about arrangement of the component embedded substrate, an input terminal, an output terminal, a gate driver, and a control IC on the mounting board.

5. The design support apparatus according to claim 4, wherein
the mounting arrangement information contains at least information about a relative positional relationship between the component embedded substrate, the input terminal, the output terminal, the gate driver, and the control IC.

6. The design support apparatus according to claim 1, wherein
the component information acquiring unit further acquires gate driver information.

7. The design support apparatus according to claim 6, further comprising:
a gate driver arrangement direction selecting unit that selects an arrangement direction of the gate driver.

8. The design support apparatus according to claim 1, wherein
the pad arrangement selecting unit further selects arrangement of a signal pad.

9. The design support apparatus according to claim 1, wherein
the mounting arrangement information further includes geometry information containing at least information about a layer structure, a copper foil thickness, and a board material of the mounting board.

10. The design support apparatus according to claim 9, further comprising:
an area information acquiring unit that acquires a required minimum area of the electrode pad on the basis of the geometry information about the mounting board and the component information.

11. The design support apparatus according to claim 10, wherein
the area information acquiring unit further derives a required minimum mounting area required for embedding the electronic component in the component embedded substrate on the basis of the component information.

12. The design support apparatus according to claim 10, wherein
the area information acquiring unit further derives a required minimum heat dissipation area of the component embedded substrate.

13. The design support apparatus according to claim 1, further comprising:
an output device that outputs pad arrangement selected by the pad arrangement selecting unit.

14. The design support apparatus according to claim 13, wherein
the pad arrangement is displayed in a changeable form.

15. The design support apparatus according to claim 14, wherein
the pad arrangement is displayed together with at least the component information.

16. A design support program that supports design of a component embedded substrate including an embedded electronic component that configures at least a part of a circuit, the program causing a computer to perform:
a process of acquiring component information about the electronic component to be incorporated in the component embedded substrate;
a process of acquiring pad information about a type and the number of electrode pads to be arranged on a surface of the component embedded substrate on the basis of the component information;
a process of acquiring mounting arrangement information about arrangement of the component embedded substrate and another component on a mounting board; and
a process of selecting arrangement of the electrode pad on the basis of the mounting arrangement information and the pad information.

17. A design support method of supporting design of a component embedded substrate including an embedded electronic component that configures at least a part of a circuit, the method comprising at least:
acquiring component information about the electronic component to be incorporated in the component embedded substrate;
acquiring pad information about a type and the number of electrode pads to be arranged on a surface of the component embedded substrate on the basis of the component information;
acquiring mounting arrangement information about arrangement of the component embedded substrate and another component on a mounting board; and
selecting arrangement of the electrode pad on the basis of the mounting arrangement information and the pad information.
